(19) United States
(12) Patent Application Publication
(10) Pub. No.: US 2010/0140433 A1
(43) Pub. Date: Jun. 10, 2010

(54) DEVICE FOR DISPLAYING AND ARRANGING MAT BOARD SAMPLES

(75) Inventors: Vanzgen John Houssian, Union City, NJ (US); Madlen Houssian, Union City, NJ (US)

Correspondence Address: DARBY & DARBY P.C., P.O. BOX 770, Church Street Station, New York, NY, 10008-0770, US

(73) Assignee: Nielsen & Bainbridge LLC, Paramus, NJ (US)

(21) Appl. No.: 12/445,240

(22) PCT Filed: Oct. 23, 2007
(86) PCT No.: PCT/US2007/082260

§ 371 Date: Apr. 10, 2009

Related U.S. Application Data
(60) Provisional application No. 60/862,543, filed on Oct. 23, 2006.
(60) Provisional application No. 60/868,714, filed on Dec. 5, 2006.

(51) Int. Cl. F16M 13/00

(52) U.S. Cl. 248/309.1

(57) ABSTRACT

A device for displaying and holding mat board corner samples is provided. The device includes two end members, between which mat board corner samples can be seated. The end members may include a plurality of notches so that a plurality of generally L-shape mat board corner samples can be seated at varying offsets relative to each other. The end members may alternatively include flat surfaces so that generally chevron-shaped mat board corner samples can be slidably seated between the end members at varying offsets relative to each other. The end members are attached to a support and can be removable seated on a display board. Art work can be removable mounted on the display board as well. Thus, mat board corner samples that are seated between the two end members can be displayed in conjunction with art work to be framed.

This Application claims priority to U.S. Provisional Application No. 60/862,543, filed Oct. 23, 2006 and U.S. Provisional Application No. 60/868,714, filed Dec. 5, 2006. The entire contents of both applications are hereby incorporated by reference in their entireties.

### BACKGROUND OF THE INVENTION

1. Field of the Invention

This invention relates generally to the display of mat board samples that can be seated on a display board and displayed in conjunction with a piece of artwork or other subject matter to be framed.

2. Discussion of the Related Art

Custom picture framing permits a customer to choose a frame and mat selection for his or her artwork that is aesthetically pleasing. The process of selecting a frame and mat combination typically involves arranging the frame and mat selections on a flat horizontal surface, typically a work table. The piece of artwork is first laid out on the work table. Then, frame and mat corner samples are arranged around the artwork to provide a mock-up illustrating how various frame and mat combinations will look with the work. Several mat board samples may be arranged on the table and inwardly spaced at various positions and shown with frame samples. This is done so that the customer can better appreciate how the artwork will look when framed with the selected frame and mat board combination.

One drawback of arranging the frame and mat board sample selection on the horizontal work table is that it may be difficult for the customer to view the selection and arrangement of the frame and mat board sample combination. The customer may be across the table from the framer as the framer selects and arranges various frame and mat selections. The customer may be situated at a distance from the arrangement and at an awkward angle, and thus it may be difficult for the customer to view the selected combination. Additionally, viewing the arrangement on a horizontal surface does not give the best perspective for viewing a frame and mat selection that is intended to be displayed on a wall. The customer may not be able to fully appreciate how the frame and mat selection will look when vertically oriented.

Another shortcoming of arranging the frame and mat board samples on a horizontal table is the difficulty of positioning the various mats with the proper inward spacing. As the mat board samples are laid over each other and presented to the customer, it becomes necessary to measure the inward spacing of each mat board sample in order to replicate the desired arrangement when the work is framed. Manually measuring the spacing of each mat board sample can be time consuming and imprecise.

U.S. Pat. No. 4,993,953 to Stein discloses a display holder for displaying proposed arrangements of artwork, mats, and frames. The artwork is held in place and covered by a transparent piece of plastic. A pair of flat clips are included for holding mat samples against the plastic cover. Guide lines are provided for aligning and positioning the artwork and the mat samples. The display includes a support which allows the artwork and mat selections to be displayed in a near vertical position.

The display holders of the prior art can be used to display artwork with frame and mat combinations. However, the use of clamps to hold the mat selections in place can be cumbersome, especially when multiple mats are being shown in combination. Additionally, the clamps themselves do not properly align and position the mats.

It is an object of the present invention is to provide an improved device for displaying mat board samples in conjunction with a work of art or other item to be framed.

### SUMMARY OF THE INVENTION

The present invention is directed to a device that permits the display of various frame and mat selections in combination with the subject matter to be framed which can be viewed in vertical and semi-vertical orientations.

In accordance with a first aspect of the invention, a removable mat board corner holder having two end members useful for holding and positioning mat board corner samples can be selectively mounted on a display board. The end members are attached to a support member and are spaced and orientated relative to each other so that mat board corner samples can be seated therebetween.

In accordance with a more particular aspect of the invention, the end members include a plurality of notches forming corresponding pairs of notches, the notches in the end members being dimensioned and arranged so that an L-shape mat board corner sample can be seated between the notch pairs. The removable mat board corner holder can be selectively mounted on a display board by seating registration members on adjacent side surfaces of the display board.

In accordance with another more particular aspect of the invention, the end members include flat surfaces. The end members are spaced and oriented relative to each other such that a chevron-shaped mat board corner sample can be slidably seated between the flat surfaces of the end members.

In accordance with another aspect of the invention, two end members are provided in conjunction with a display board for mounting the subject matter to be framed. The end members are attached to the display board and are spaced and orientated relative to each other so that mat board corner samples can be seated therebetween. The end members may include a plurality of notches forming corresponding pairs of notches, the notches in the end members being dimensioned and arranged so that an L-shape mat board corner sample can be seated between the notch pairs. Alternatively, the end members may include flat surfaces. The end members are spaced and oriented relative to each other such that a chevron-shaped mat board corner sample can be slidably seated between the flat surfaces of the end members.

### BRIEF DESCRIPTION OF THE DRAWINGS

The foregoing and other features of the present invention will be more readily apparent from the following detailed description and drawings of the illustrative embodiments of the invention in which:

FIG. 1 is a perspective view of a mat board corner holder seated on a display board which is supported by a stand according to an embodiment of the present invention;

FIG. 2 is a plan view of the mat board corner holder;

FIG. 3 is a perspective view of the mat board corner holder of FIG. 2;

FIG. 4 is a sectional side view taken along the line 4-4 of FIG. 3 of the mat board corner holder with mat board corner samples seated in position;

FIG. 5 is an enlarged partial plan view of the mat board corner holder of FIG. 2 seated on a display board showing a mat board corner sample in combination with artwork;

FIG. 6 is an enlarged partial plan view of the mat board corner holder of FIG. 2 showing exemplary measurement markings;

FIG. 7 is a side view of the display board mounted on an alternative stand;

FIG. 8 is a partial rear view of the display board mounted on the stand of FIG. 7;

FIG. 9 is a partial plan view of the mat board corner holder of FIG. 2 with a frame accent fillet holder;

FIG. 10A is a sectional side view taken along the line 10-10 of FIG. 9;

FIG. 10B is a sectional side view taken along the line 10-10 of FIG. 9 showing an alternate frame accent fillet holder arrangement;

FIG. 11 is a partial plan view of the mat board corner holder of FIG. 2 with a mat board accent fillet holder;

FIG. 12 is a sectional side view taken along the line 12-12 of FIG. 11;

FIG. 13 is a perspective view of a mat board corner holder according to another embodiment of the invention;

FIG. 14 is a plan view of the mat board corner holder of FIG. 13 with a mat board corner sample slidably seated therebetween;

FIG. 14A is an enlarged view of the mat board corner holder of FIG. 14 showing a spring member;

FIG. 14B is an enlarged view of the mat board corner holder of FIG. 14 showing the spring member in a compressed state; and

FIG. 15 is a sectional side view taken along the line 15-15 of FIG. 14 of the mat board corner holder with mat board corner samples seated in position.

FIG. 16 is a perspective view of a display holder which is supported by a stand according to an embodiment of the present invention;

FIG. 17 is a plan view of the display holder;

FIG. 18 is an enlarged plan view of a mat holder of the display holder of FIG. 17;

FIG. 19 is a sectional side view taken along the line 4-4 of FIG. 18 of the end member with mats seated in position;

FIG. 20 is an enlarged partial plan view of the display holder of FIG. 17 showing the installation of artwork and mat and frame selections;

FIG. 21 is a perspective view of a removable mat board corner holder having two end members according to another embodiment of the invention;

FIG. 22 is a partial plan view of the removable mat board corner holder of FIG. 21 shown seated on a display board;

FIG. 23 is a sectional side view taken along the line 8-8 of FIG. 22.

### DETAILED DESCRIPTION OF THE PREFERRED EMBODIMENTS

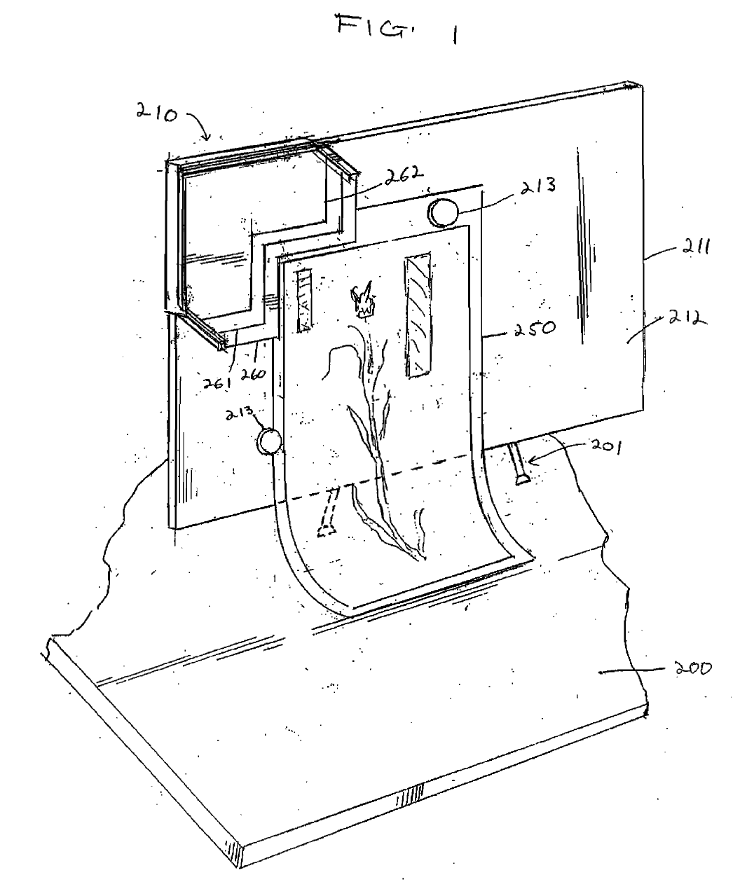

Referring to FIGS. 1 and 5, a mat board corner holder 210 in accordance with a preferred embodiment of the invention comprises an L-shaped base member 240 and a pair of end members 220, 224 having a plurality of notches 221. The notched end members 220, 224 are angled and spaced as shown in FIG. 5 so that a mat board corner sample 260 can be seated between a pair of notches, the pair consisting of one notch located on end member 220 and the other notch located on end member 224. Each pair of notches has a specified inward offset such that a mat board corner sample 260 can be held in the mat board corner holder 210 at different inward offset values depending on which notch pair the mat board corner sample 260 is seated between. The mat board corner holder 210 can hold a plurality of mat board corner samples 260, 261, 262 seated between several notch pairs, as shown in FIG. 1, which permits several mat board corner samples of various colors and characteristics to be arranged with varying inward offsets. The mat board corner holder 210 is seated on a display board 211 which has a piece of artwork 250 mounted thereon. The mat board corner samples can be removed and replaced with other corner samples and the inward offset arrangement of the mat board corner samples can be adjusted in relation to the artwork 250. While the mat board corner holder 210 is seated on the display board 211, a frame corner sample 264 may be seated on the display board 211 overlying the mat board corner holder 210 and the mat board corner samples. Thus, the mat board corner holder 210 provides a means for holding and displaying a combination of mat board corner samples 260, 261, 262, which can be adjustably arranged at varying inward offsets, in conjunction with a frame corner sample 264 and a piece of artwork 250. Other framing items, such as fillet corner samples, may be displayed as well.

The mat board corner holder 210 is preferably removable so that it can be seated on a variety of rectangular display boards. A removable mat board corner holder also provides the advantage that several mat board corner holders, each holding various mat board corner samples, can be interchangeably seated on the display board, which permits the customer to easily view and compare various mat board corner sample combinations. The mat board corner holder 210 can be mounted on the display board 211 by seating the registration member 241 of the mat board corner holder 210 on the side edge of the display board 211.

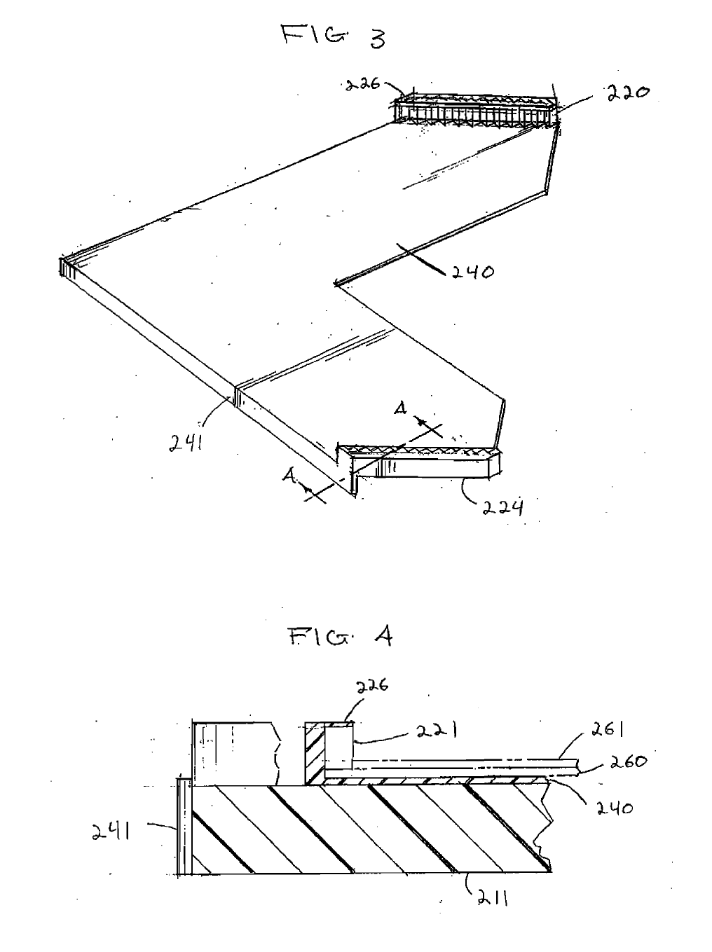

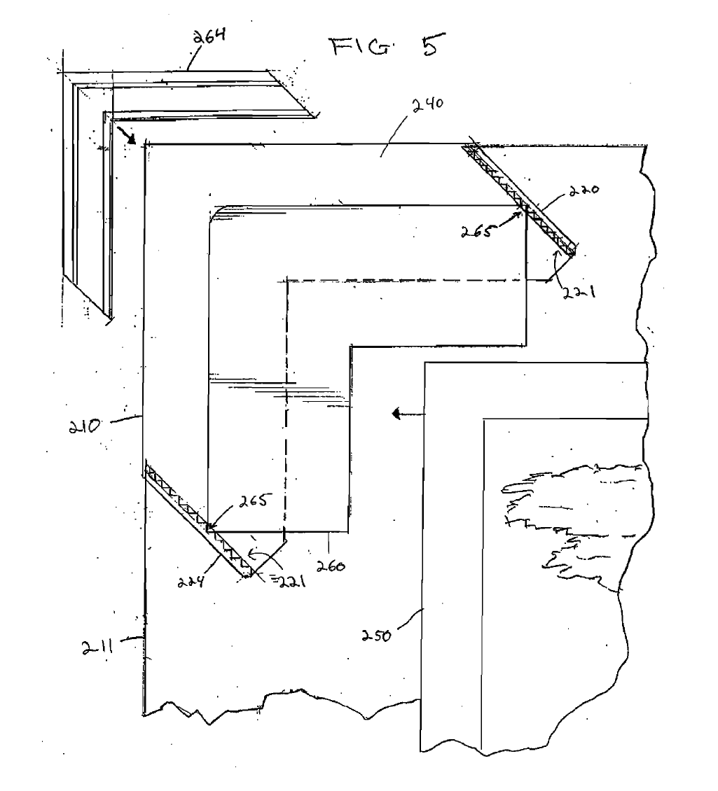

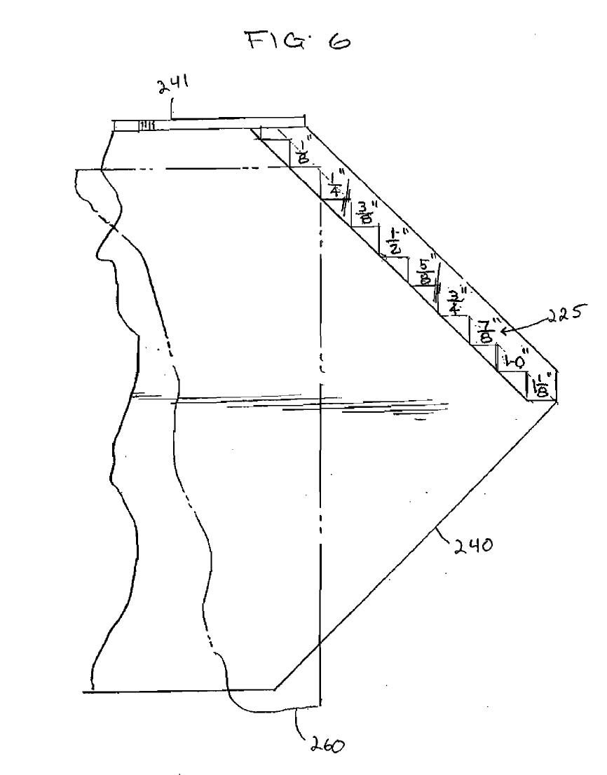

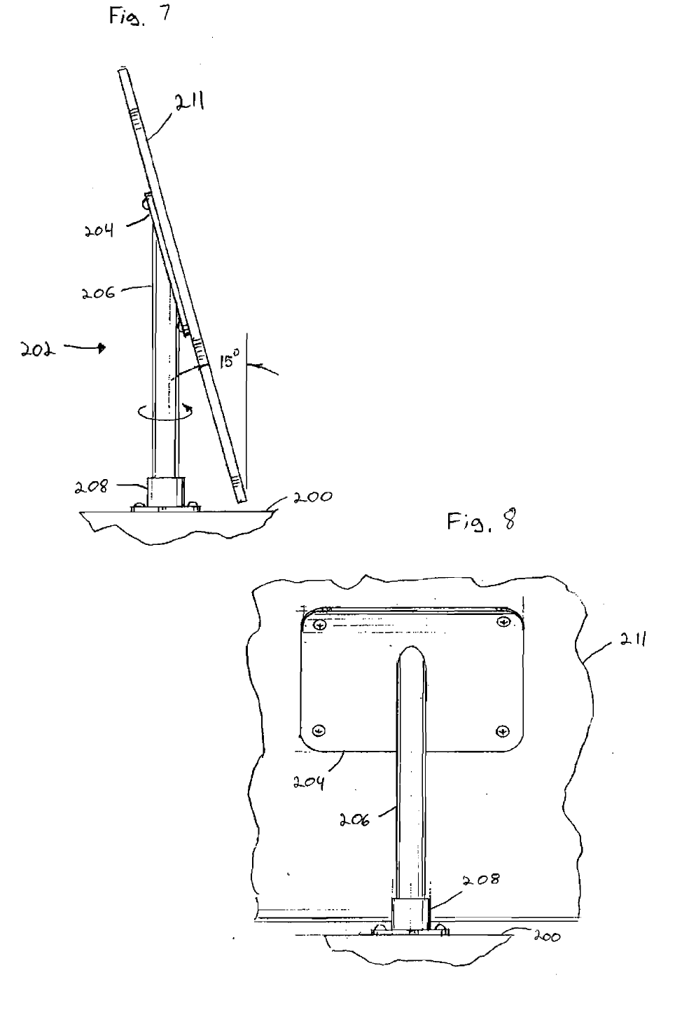

As shown in FIG. 3, the mat board corner holder 210 includes a pair of end members 220 and 224 connected to a base member 240, and a registration member 241. Each end member 220, 224 includes a plurality of notches 221. The mat board corner holder 210 is dimensioned so that a mat board corner sample 260 can be seated between corresponding notches 221 of the end members 220 and 224.

Each notch on the notched end members 220, 224 is preferably provided with a marking 225, such as characters or dimensional measurements, i.e., (⅛″) as shown in FIG. 6. The markings 225 indicate the offset distance of the notches. The notches 221 of the end members 220, 224 are each arranged and oriented such that they form corresponding notch pairs. For example, the notch marked as (¼″) on end member 220 and the notch marked as (¼″) on end member 224 are at equal distances from the outer sides of the mat board corner holder 210, thus forming a corresponding notch pair. The mat board corner holder 210 is dimensioned and the end members 220, 224 are positioned on the mat board corner holder 210 such that a mat board corner sample 260 can be snuggly seated between a pair of corresponding notches on end members 220 and 224, as shown in FIG. 5. The mat board corner sample 260 is seated such that the outer end corners 265 of the legs of the mat board corner samples are both seated in the notches 221 of the corresponding notch pair. Thus, a corner sample of mat board can be positioned for display by being seated between a corresponding notch pair on end members 220 and 224 of the mat board corner holder 210. The snug fit of the mat board corner sample 260 between the corresponding notches 221 positions the mat board corner sample so that it is squared with the side edges of the mat board corner holder 210 and holds the mat board corner sample in place while the mat board corner holder 210 is orientated in a vertical or near-vertical position. The mat board corner holder 210 is mounted on the display board 211 and mat board corner samples may be displayed in combination with artwork 250, as shown in FIG. 5.

The mat board corner sample 260 can be displayed at different inward offsets relative to the artwork to be framed depending on which notch pair the mat board corner sample is seated in. The notches 221 are dimensioned such that the notches are located on the end members 220, 224 at a set interval. The interval dimension can be set at any desired value such as ⅛″, as shown in FIG. 6, 3/16″ or ¼″, preferably being 3/16″. Thus, seating two mat board corner samples, each in adjacent notch pairs where the interval dimension is ⅛″, will result in the two mat board corner samples having an offset of ⅛″ relative to each other. Seating the mat board corner samples in different notch pairs will position the mat board corner samples with different inward offsets. For example, a mat board corner sample seated in the notch pair denoted (⅞″) will have a inward offset of ⅞″. Alternatively, the notches 221 may be formed on the end members with various interval dimensions as long as each pair of corresponding notches on each end member have the same offset.

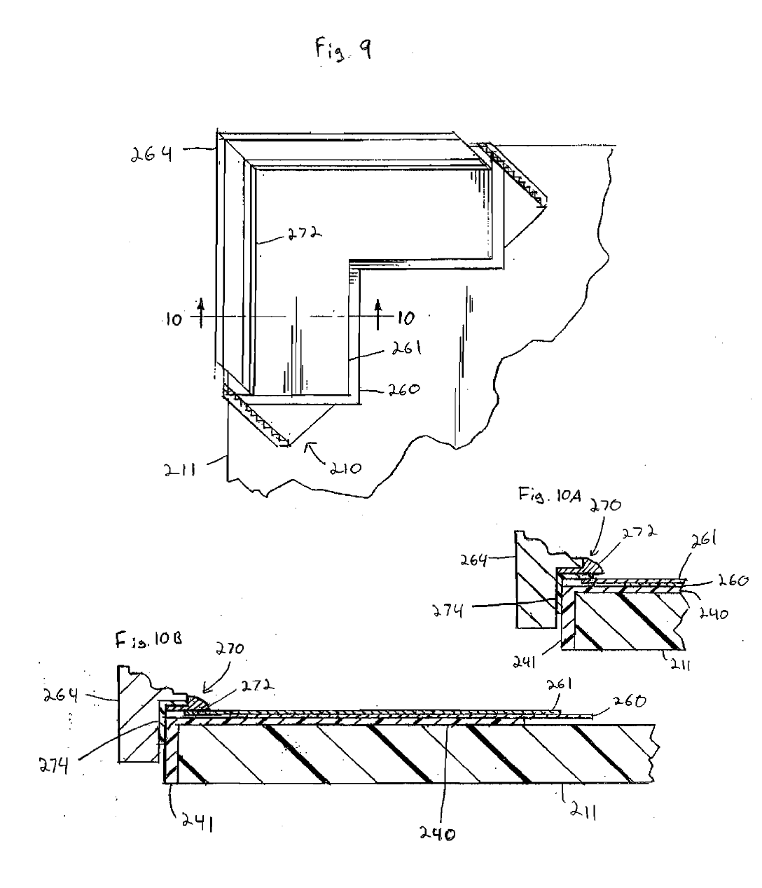

A cover 226 may be provided on each end member 220 and 224, as shown in FIGS. 3 and 4. Preferably the cover 226 is made from a transparent plastic material. The cover 226 is positioned on the end members so that the cover overlays the notches 221 in the end members 220, 224. The overhanging portion of the cover helps to maintain the mat board corner samples 260, 261 in position when the mat board corner holder 210 is in the vertical or near-vertical position. The overhanging portion of the cover 226 is particularly useful for maintaining the mat board corner samples in position when the fit of the mat board corner samples between the notches 221 is slightly loose.

FIG. 4 is a cross-sectional view of the mat board corner holder 210 of FIG. 3 mounted on the display board 211 with mat board corner samples 260, 261 seated in notches 221. The registration member 241 facilitates the proper seating of the mat board corner holder 210 when it is placed on the display board 211. The mat board corner holder 210 is properly seated when the registration member 241 is flushly abutted against the surface of the sides of the display board 211, as shown in FIGS. 4 and 5. The registration member 241 ensures that the mat board corner holder 210 is properly mounted on and aligned with the display board 211.

FIG. 5 illustrates the mounting of artwork with a combination of mat board and frame corner samples. The mat board corner samples may be slightly flexed so that they can be inserted under cover 226 and seated in a pair of notches 221. Once the mat board corner sample is inserted it is released and unflexes so that it is snuggly seated in a corresponding pair of notches as shown with mat board corner sample 260. Several mat board corner samples can be inserted into the mat board corner holder 210 to create a mat board corner sample combination as shown in FIG. 1. With the desired mat board corner sample combination in place, the artwork 250 may be slid under the base member 240 of the mat board corner holder 210 and positioned with the mat board corner samples overlying the work. Alternatively, the artwork 250 may be placed on the display board first and then mat board corner holder with the mat board corner samples may be mounted on the display board 211 overlaying the artwork 250. The artwork 250 is held in place by magnets 213. A frame corner sample 264 is then seated on the corner of the display board 211 over the mat board corner holder 210 and the mat board corner samples, as shown in FIG. 5. Thus, a frame and mat board corner sample combination may be presented on a display board together with artwork in a vertical or near-vertical orientation.

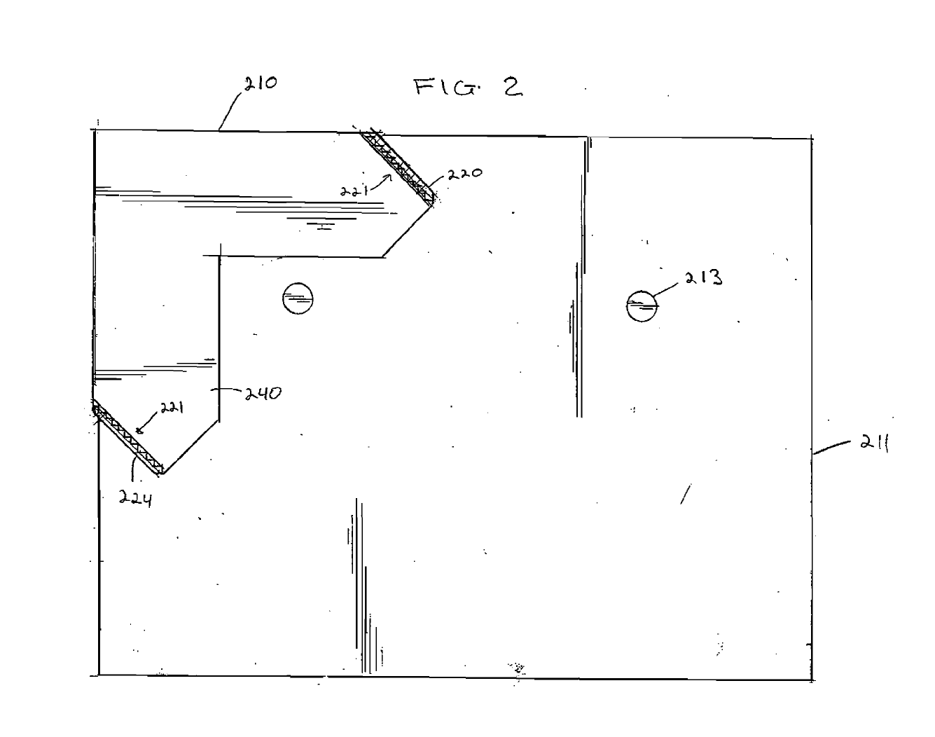

As shown in FIGS. 1 and 2, magnets 213 may be magnetically secured to the display board 211. The display board 211 may be made out of metal or have metallic or magnetic material within or covering the display board 211 so that magnets 213 can be magnetically secured to it. Preferably the display board 211 includes a stainless steel sheathing such that magnets 213 can be magnetically secured to the generally flat outer surface 212 of the display board 211. As shown in FIG. 1, the magnets 213 can be used to hold the artwork 250 against the display board 211 by placing the artwork 250 between the magnets 213 and the display board 211. The magnets 213 can be further provided with a covering, such as a fabric covering or a soft leather covering, in order to better protect the artwork 250. Other suitable means for holding the artwork 250 against the display board 211 exist, such as including a strip of releasable adhesive on the display board 211.

As shown in FIG. 1, the display board 211 may be provided in combination with a tripod type stand 201. The stand assists in the holding and displaying of the artwork with mat board and frame corner sample combinations. The stand 201 may be an easel or any other suitable means for supporting the display board 211.

FIGS. 7 and 8 illustrate a preferred stand 202 for the display board 211. The stand 202 includes a board mounting member 204, a post 206, and a table mounting member 208. The board mounting member 204 has four holes so that the board mounting member 204 can be attached to the display board 211 with screws, bolts, or the like. The post 206 is preferably a cylindrical tube. The top of the post 206 is angled at 15 degrees and welded to the board mounting member 204. The angle at the top of the post 206 sets the angle at which the display board 211 is supported, which is preferably 15 degrees from vertical, as shown in FIG. 7. The post 206 is mounted in the table mounting member 208, which is mounted to the table 200. The post 206 is mounted such that the post 206 and display board 211 can rotate side to side.

Referring to FIGS. 9-12, fillet corner samples are shown which can be used in combination with the mat board corner holder 210. FIGS. 9, 10A and 10B illustrate an frame accent fillet holder 270 that includes a fillet corner sample 272 connected to a registration bracket 274. The frame accent fillet holder 270 is used for providing a fillet corner sample 272 proximate to the frame corner sample 264. The fillet corner sample 272 is connected to a registration bracket 274. FIGS. 10A and 10B illustrate alternate configurations for connecting the fillet corner sample 272 to the registration bracket 274, with FIG. 10A showing the fillet corner sample 272 mounted on the top of the registration bracket 274 and FIG. 10B showing the fillet corner sample 272 mounted on the bottom of the registration bracket 274. The fillet corner sample 272 may be connected to the registration bracket 274 using double sided tape, adhesive, or any other suitable means. As shown in FIGS. 10A and 10B, the mat board corner holder 210 with mat board corner samples 260 and 261 is first seated on the display board 211 and the frame accent fillet holder 270 is seated on the display board 211 overlaying the mat board corner samples and the mat board corner holder. The frame corner sample 264 is then seated on the display board 211 overlaying the frame accent fillet holder 270 and the mat board corner holder 210. The arrangement is such that the fillet corner sample 272 abuts the frame corner sample 264.

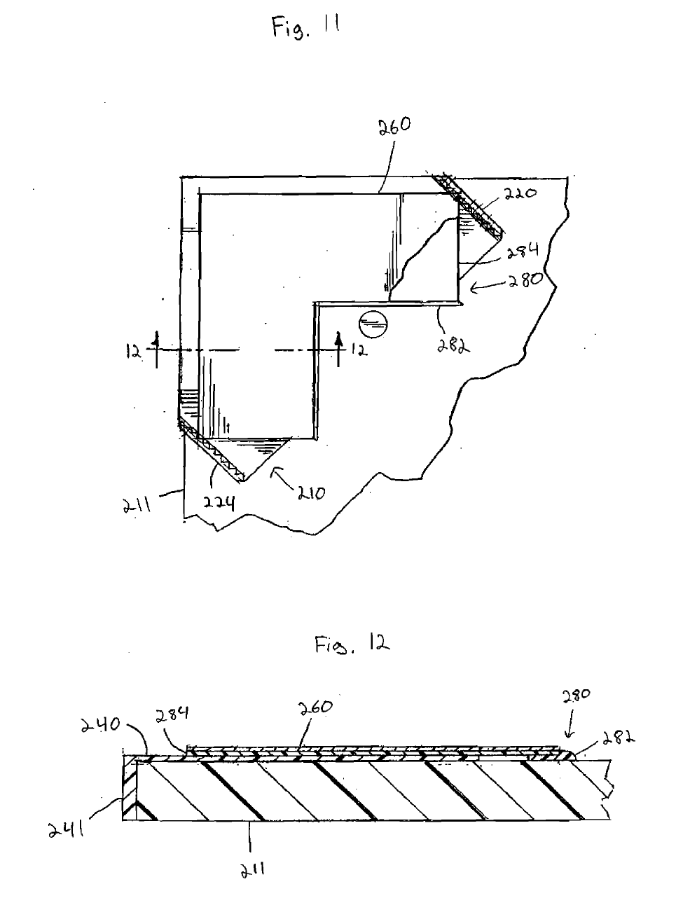

A mat board accent fillet holder 280 may be used in combination with the mat board corner holder 210, as shown in FIGS. 11 and 12. The mat board accent fillet holder 280 includes a fillet corner sample 282 connected to a mounting member 284. The mounting member 284 can be made from various materials including wood, plastic, or metal, and is preferably made from transparent plastic. The mounting member 284 is preferably the same size and shape as a mat board corner sample 260 so that a mat board corner sample 260 can overlay the mounting member 284 and the fillet corner sample 282 will abut the mat board corner sample 260 as shown in FIGS. 11 and 12. The mat board corner holder 210 is mounted on the display board 211 and the mat board accent fillet holder 280 is seated between the notched end members 220, 224 in a corresponding notch pair. The mat board corner sample 260 is also seated between the end members 220, 224 in the same corresponding notch pair as the mat board accent fillet holder 280 so that the mat board corner sample 260 overlays the mounting member 284 and the fillet corner sample 282 abuts the mat board corner sample 260. Additional mat board corner samples may also be seated between the end members in other notch pairs.

In addition to mat board corner samples and/or a mat board accent fillet holder, a spacer (not shown) having the same shape as a mat board corner sample can be seated between the end members 220, 224 in a corresponding pair of notches. The spacer may be interposed between two mat board corner samples in order to create a depth effect. The spacer can be made of various materials of varying thicknesses, but is preferably a piece of foam board having front and rear paper backings and a foam core.

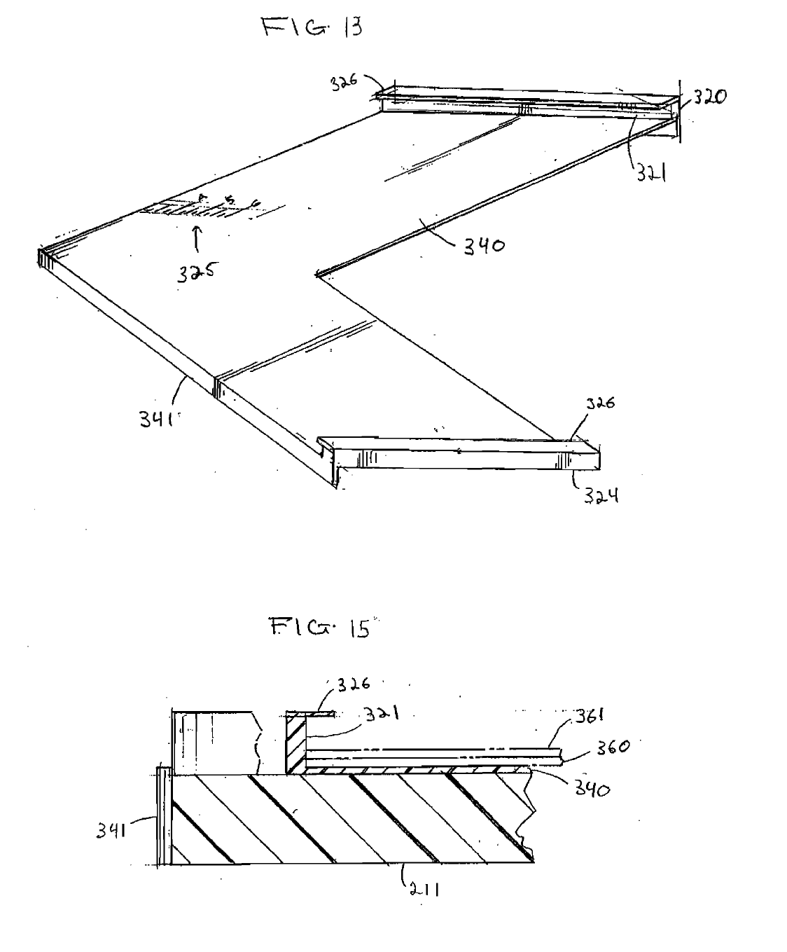

FIGS. 13-15 illustrate a mat board corner holder 310 according to another embodiment of the present invention which permits the position of mat board corner samples 360 to be slidably adjusted.

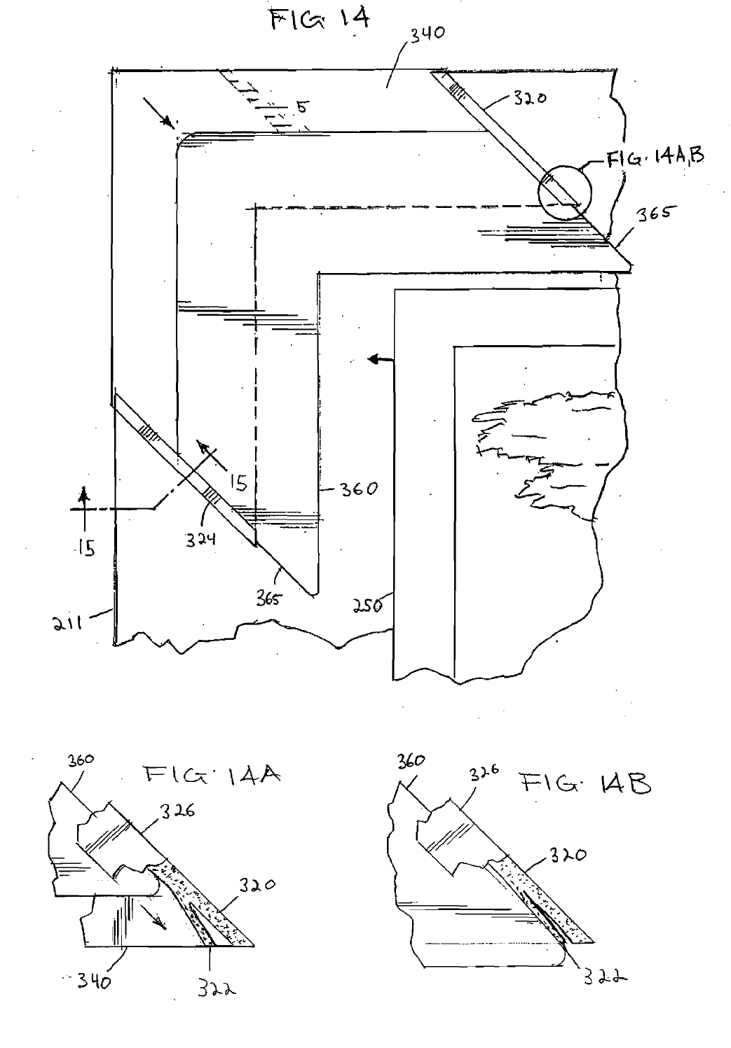

In accordance with a preferred embodiment, the mat board corner holder 310 includes an L-shaped base member 340, a pair of end members 320 and 324, and a registration member 341. The end members 320, 324 are mounted on the base member 340 and are angled and spaced as shown in FIG. 14. The end members 320, 324 each have a generally flat inner surface 321. The mat board corner sample 360 has an angled edge 365 giving the mat board corner sample a chevron-like shape as depicted in FIG. 14 so that a mat board corner sample 360 can be seated therebetween. The mat board corner sample 360 can be seated between the inner surfaces 321 of the end members 320, 324 with the angled edge 365 of the mat board corner sample 360 seated against the flat inner surfaces 321 of the end members 320, 324 such that the position of mat board corner sample can be slidably adjusted. The mat board corner holder 310 can hold a plurality of mat board corner samples seated between the end members 320, 324, which permits several mat board corner samples of various colors and characteristics to be arranged with varying inward offsets. The mat board corner holder 310 is seated on a display board 211 which has a piece of artwork 250 mounted thereon. The mat board corner samples can be removed and replaced with other mat board corner samples and the inward offset arrangement of the mat board corner samples can be slidably adjusted in relation to the artwork 250. With the mat board corner holder 310 seated on the display board 211, a frame corner sample 264 may be seated on the display board 211 overlying the mat board corner holder 310 and the mat board corner samples, similar to as shown in FIG. 5. Thus, the mat board corner holder 310 provides a means for holding and displaying a combination of mat board corner samples, which can be slidably adjusted at varying inward offsets, in conjunction with a frame corner sample 264 and a piece of artwork 250. Other framing items, such as fillet corner samples may be displayed as well.

The mat board corner holder 310 is preferably removable so that it can be seated on a variety of rectangular display boards. A removable mat board corner holder also provides the advantage that several mat board corner holders, each holding various mat board corner samples, can be interchangeably seated on the display board, which permits the customer to easily view and compare various mat board corner sample combinations.

The mat board corner holder 310 also includes covers 326, preferably made from transparent plastic, which may be provided on each end member 320 and 324. Each cover 326 is positioned on the end members so that the cover overhangs the end members 320, 324.

Several of the components of the mat board corner holder can be separate parts or can be integral with each other, for example, the cover may be integral with the end members and the registration member may be integral with the base member.

FIG. 14 illustrates the mounting of artwork in combination with a mat board corner sample. The mat board corner sample 360 may be slidably inserted under cover 326 and seated between end members 320 and 324. The end members 320 and 324 are spaced such that the mat board corner sample is snuggly seated between the end members. The fit of the mat board corner sample is such that the friction force between the mat board corner sample and the end members is sufficient to hold the mat board corner sample in place but also allows the position of the mat board corner sample to be slidably adjusted. In order to ensure that the mat board corner sample is seated with the proper amount of friction force, the end members may each include a spring member 322 as shown in FIGS. 14A and 14B. The end members 320 and 324 are formed such that each integral spring member 322 projects inward as shown in FIG. 14 A. The spring members are resiliently compressible so that when a mat board corner sample is seated into position between the end members, each spring member compresses as shown in FIG. 14B. This ensures that mat board corner sample is snuggly seated between the end members and the friction force is sufficient to hold the mat board corner sample in place while also allowing the mat board corner sample to be slidably adjusted. Alternatively, other means such as a metal flat spring may be connected to the end members in order to assist in holding the mat board corner sampler in place.

Additional mat board corner samples may be inserted between the end members 320, 324. With the desired mat board corner sample combination is in place, the artwork 250 may be slid under the base member 340 of the mat board corner holder 310 and positioned with the mat board corner samples overlying the work. Alternatively, the artwork 250 may be placed on the display board first and then the mat board corner holder with the mat board corner samples may be mounted on the display board 211 overlaying the artwork 250. The artwork 250 is held in place by magnets 213. A frame corner sample 264 can then be seated on the corner of the display board 211 overlaying the mat board corner holder 310 and the mat board corner sample 360, as similarly shown in FIG. 5 with mat board corner holder 210. The inward offset of the mat board corner samples relative to the artwork to be framed can be easily adjusted by sliding the mat board corner samples as they are seated between end members 320 and 324 until the desired inward offset positions are obtained. Thus, a mat board corner sample combination may be presented on a display board together with artwork in a vertical or near-vertical orientation.

A frame accent fillet holder 270 of FIGS. 9-10 may be used in combination with the mat board corner holder 310. The frame accent fillet holder 270 may be displayed on the display board by first seating the mat board corner holder on the display board, then seating the frame accent fillet holder on the display board overlaying the mat board corner holder, and next seating a frame corner sample on the display board overlaying the frame accent fillet holder. A mat board accent fillet holder 280 may be modified such that the mounting member 284 has a chevron-like shape of the mat board corner sample 360. A mat board accent fillet holder with a chevron-like shaped mounting member may be used in combination with the mat board corner holder 310 by seating the mat board accent fillet holder between the end members in a manner similar to the seating of a mat board corner sample 360.

The mat board corner holder 310 may also include a scale and a series of measurement markings 325 as shown in FIG. 13. The scale and markings 325 can be used to quickly determine the distance from the side edges of the mat board corner holder 310 to the inner edge of the mat board corner samples. The scale and measurement markings can also be arranged on the end members 320, 324, similar to as shown on the mat board corner sample holder 210 of FIG. 6.

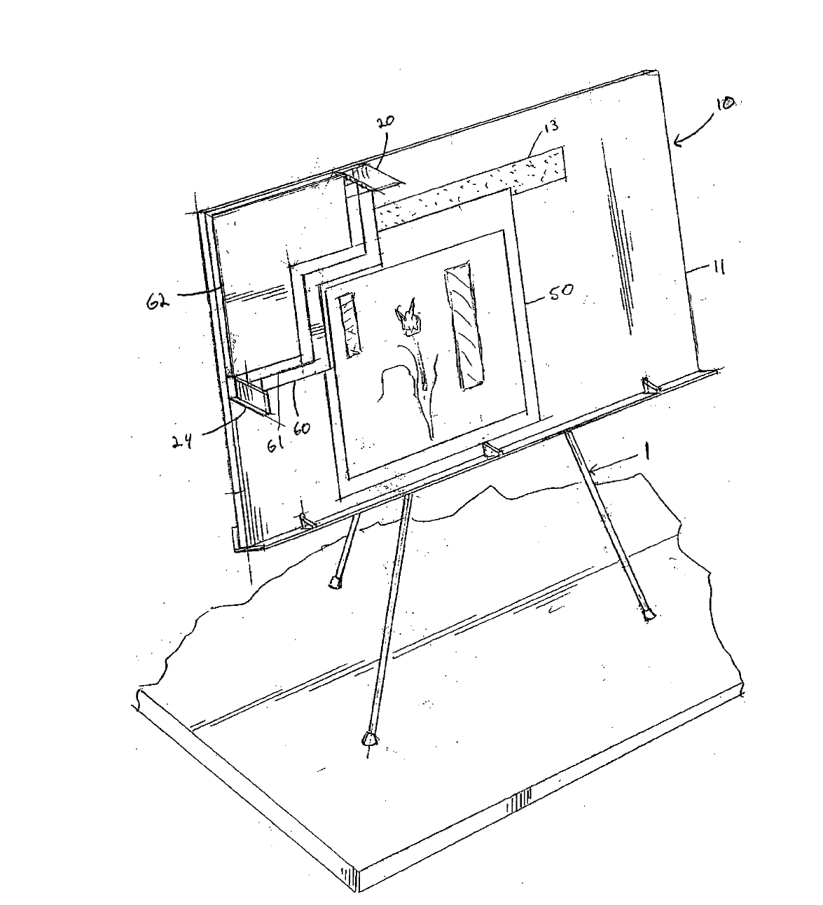

FIG. 15 is a cross-sectional view of the mat board corner holder 310 of FIG. 14 mounted on the display board 211 with mat board corner samples 360, 361 seated between end members 320, 324. The registration member 341 facilitates the proper seating of the mat board corner holder 310 when it is placed on the display board 211. The mat board corner holder 310 is properly seated when the registration member 341 is flushly abutted against the surface of the sides of the display board 211, as shown in FIGS. 14 and 15. The registration member 341 ensures that the mat board corner holder 310 is properly mounted on and aligned with the display board 211.

The mat board corner holder 310 can be used in conjunction with a display board that is supported by a stand or easel of FIG. 1 or FIGS. 7 and 8.

FIGS. 21-23 illustrate a mat board corner holder 110 according to another embodiment of the invention that includes a pair of end members 120 and 124.

The mat board corner holder 110 is intended to be used in connection with a display board 111 and provides a means for displaying mat board samples in connection with a piece of artwork. The mat board corner holder 110 includes a pair of end members 120 and 124 connected by a crossbar 140. The end members 120, 124 include a plurality of notches 121 forming a set of corresponding notch pairs between end members 120 and 124, the notches being dimensioned to hold a mat board corner sample and positions the mats at a range of inward offset locations depending on which notch pair the mat is seated between. A cover 126, preferably made from transparent plastic, may be laid over end members 120 and 124. The cover 126 is positioned on the end members so that the cover overhangs the notches 121 in the end members 120, 124.

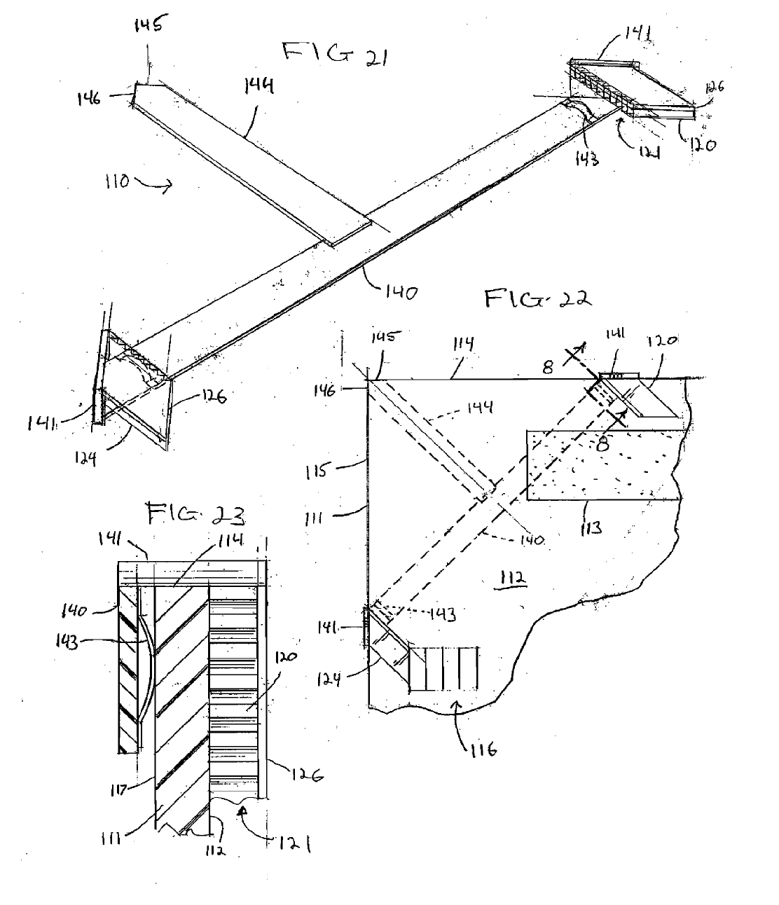

The end members 120, 124 are connected to the crossbar 140 by registration panels 141, the end members, crossbar, and panels essentially forming a U-shaped channel, as shown in FIG. 23. The mat board corner holder 110 is seated on the display board 111 by placing the mat board corner holder 110 on the board 111 such that the board 111 is disposed between the crossbar 140 and the end members 120 and 124, and the registration panels 141 are seated on adjacent sides 114 and 115 of the board 111. Springs 143 are provided on the crossbar 140. The springs 143 push against the rear surface 117 of the display board 111 and ensure that the end members 120 and 124 are properly abutted against mounting surface 112 of the board 111. The registration panels 141 facilitate the proper seating of the mat board corner holder 110 when it is placed on the display board 111. The mat board corner holder 110 is properly seated when the registration panels 141 are flushly abutted against the surface of sides 114 and 115 of the display board, as shown in FIGS. 22 and 23.

Additionally, a orientation member 144 is provided to help ensure that the mat board corner holder 110 is properly seated on the display board 111. One end of the orientation member 144 is beveled, with surfaces 145 and 146 coming together to form a point. The opposite end of the orientation member 144 is connected to the crossbar 140. The orientation member 144 is positioned and dimensioned so that the orientation member 144 bisects the right-angled triangle formed by the crossbar 140 and the sides 114 and 115 of the display board 111, as shown in FIG. 8. The proper seating of the mat board corner holder 110 can be confirmed by checking that surfaces 145 and 146 of the orientation member 144 are flush with the sides 114 and 115 of the display board 111, respectively.

The crossbar 140 is dimensioned to provide the proper spacing between the end members 120 and 124. The crossbar 140 controls the distance between the end members 120 and 124, and thus provides the proper spacing between the corresponding notch pairs, so that a mat board corner sample can be inserted and snuggly seated between a pair of corresponding notches of the holders. Adjusting the length of the crossbar would allow for mat corner samples of different sizes to be seated between the notch pairs of the holders.

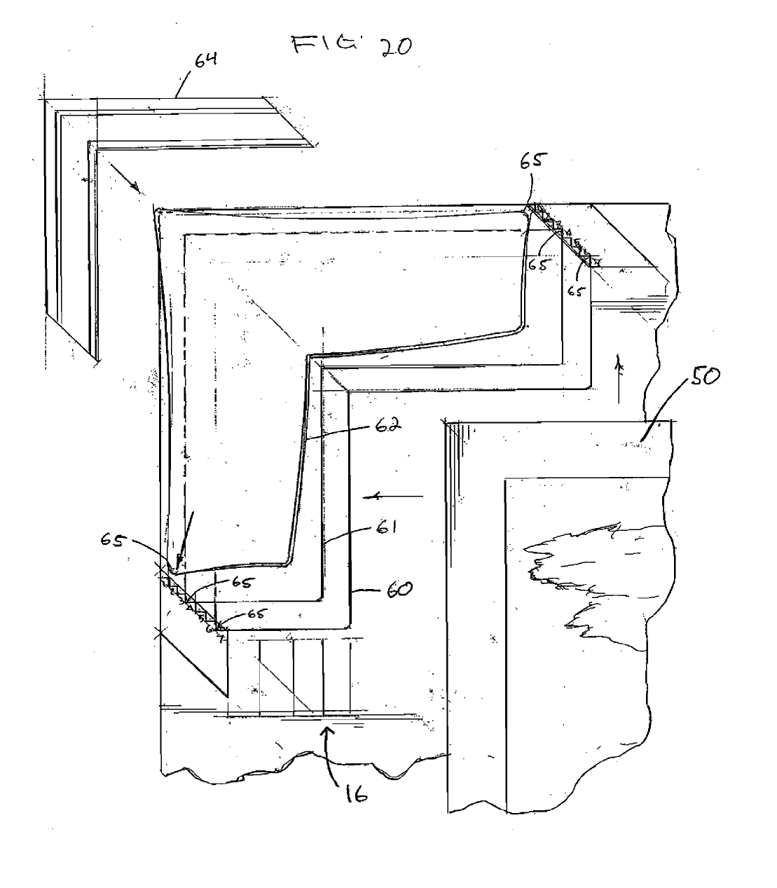

The mat board corner holder 110 can be seated on a display board 111, as shown in FIG. 22. Mat board corner samples and spacers can be seated between the corresponding notch pairs. The mat board corner samples may be slightly flexed so that they can be inserted under cover 126 and seated in a pair of notches 121. Once the mat is inserted it is released and unflexes so that it is snuggly seated in a corresponding pair of notches. Once the desired mat combination is in place, the artwork may be slid under the mats and positioned with the mats overlying the work. Alternatively, the artwork may be laid down first and then the mat board corner samples may be placed on top of it. The display board 111 includes an adhesive strip 113 or any other means for releasable securing a piece of artwork to the display board. A frame corner can then be seated on the corner of the display board 111 and rests over the mats similarly as shown in FIG. 20. Thus, a frame and mat board combination may be presented in combination in a horizontal, vertical, or semi-vertical orientation.

The display board 111 may also include a series of measurement markings 116 as shown in FIG. 22. The markings 116 can be used to quickly determine the distance from the edges 114 and 115 of the display board 111 to the inner edge of the mat boards.

The mat board corner holder 110 can be used in conjunction with a display board that is supported by a stand or easel similar to the illustration of FIG. 16.

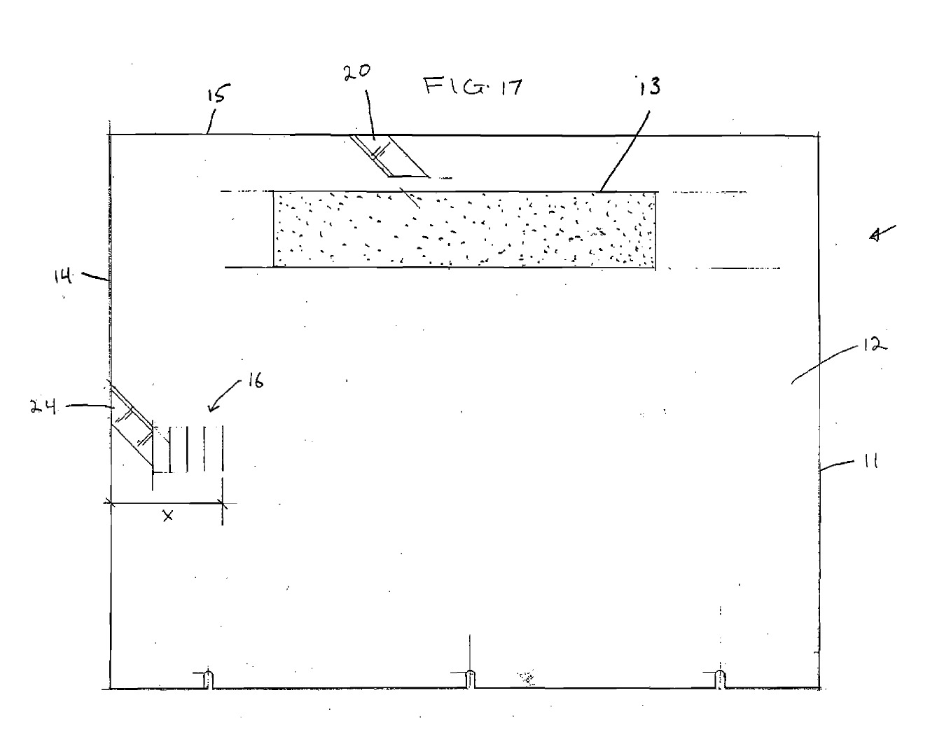

FIGS. 16-20 illustrate a display holder 10 according to another embodiment of the present invention.

The display holder 10 includes a generally rectangular display board 11 and end members 20 and 24 mounted on the display board 11 which are adapted to seat mat board corner samples 60-62.

The display board 11 has a generally flat surface 12. Flat surface 12 provides a surface for supporting a piece of artwork 50. An adhesive strip 13 is included with the display board 11 as a means for releasably securing the work 50 to the display board 11.

The adhesive strip 13 can be a strip of paper with a releasable type adhesive on the outwardly facing surface. The adhesive strip 13 may be mounted on top of surface 12 or the strip 13 may be inlaid into the display board 11 such that the outwardly facing adhesive surface of strip 13 is flush with surface 12. The outwardly facing surface of adhesive strip 13 may include any releasable type adhesive suitable for holding a piece of artwork, the adhesive allowing the artwork to be removed or repositioned without damaging or tearing the artwork. A suitable adhesive may include an acrylate type adhesive similar to that used on Post-it® brand sticky notes or message boards available from 3M company. Various other releasable securement means for holding the work 50 may be used such as a metal strip and magnets, pins and a material suitable for receiving the pins (e.g. cork board), or any other suitable means for releasably securing the work 50 to the base 11. The adhesive strip 13 holds the work 50 in place while the display holder 10 is orientated in a vertical or semi-vertical position.

End members 20 and 24 are mounted on the display board 11. The end members 20, 24 can be made of various materials including wood and plastics, preferably being made of plastic. As can be seen in FIG. 18, each end member includes a plurality of notches 21. The end member 20 of FIG. 18 has ten notches but the end members can have as many notches as desired.

Each notch is preferably provided with an identifying marking 25, such as characters or numerals “1-10” as shown in FIG. 18. The end members 20, 24 are each positioned and oriented on the display board 11 such that corresponding notches of end members 20, 24 are equidistantly spaced from the side edges 14 and 15 of display board 11. For example, the notch identified as “5” on end member 20 and the notch identified as “5” on end member 24 are at equal distances from the edges 14 and 15, thus forming a corresponding notch pair. The end members 20, 24 are positioned on the display board 11 such that a mat board corner sample 60 can be snuggly seated between two corresponding notches on end members 20 and 24, as shown in FIG. 20. The mat board corner samples 60-62 are seated such that the outer end corners 65 of the legs of the mat boards are both seated in the notches 21 of a corresponding notch pair. Thus, a corner sample of mat board can be positioned for display by being seated between a corresponding notch pair on end members 20 and 24. The snug fit of the mat board corner sample 60 between the corresponding notches 21 positions the mat board corner sample so that it is squared with the side edges 14 and 15 of the display board 11 and holds the mat board corner sample in place while the display holder 10 is orientated in a vertical or semi-vertical position.

The mat board corner sample 60 can be displayed at different inward offsets depending on which notch pair the mat board corner sample is seated in. The notches 21 are dimensioned such that the notches are located on the end member at a set interval. The interval dimension 27 can be set at any desired value such as ⅛″, 3/16″, ¼″, preferably being 3/16″. Therefore, seating two mats, each in adjacent notch pairs, where the interval dimension 27 is 3/16″ will result in the two mats having an inward offset of 3/16″ from each other. Seating the mat board corner samples in different notch pairs will position the mat board corner samples on the display with different inward offsets, for example, a mat board corner sample seated in the notch pair denoted “10” will have a greater inward offset as compared to a mat board corner sample seated in the notch pair denoted “1”. Additionally, the notches 21 may be formed on the end members at different intervals so that, for example, some notches provide a ⅛″ offset and some provide a ¼″ offset, as long as the two corresponding notches have the same offset.

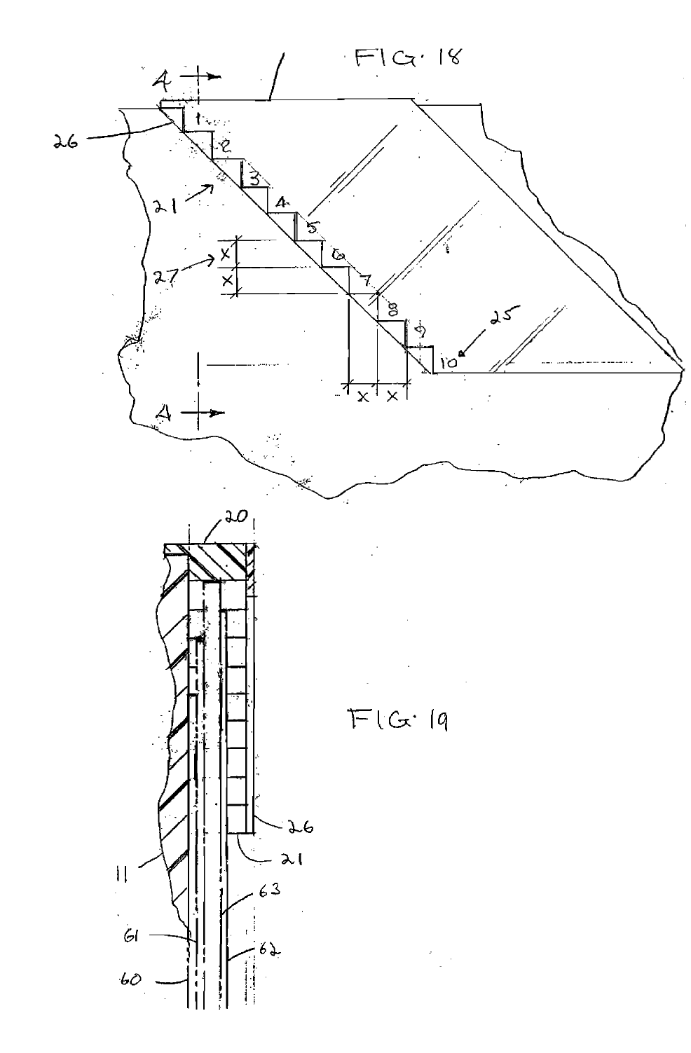

A cover 26 may be laid over end members 20 and 24, as shown in FIGS. 18 and 19. Preferably the cover 26 is made from a transparent plastic material. The cover 26 is positioned on the end members so that the cover overlays the notches 21 in the end members 20, 24. The overhanging portion of the cover helps to maintain the mat board corner samples 60-62 in position when the display 10 is in the vertical or semi-vertical position. The overhanging portion of the cover 26 is particularly useful for maintaining the mat board corner samples when the fit of the mat board corner samples between the notches 21 is slightly loose.

FIG. 4 is a cross-sectional view of the end member 20 of FIG. 18 with mat board corner samples 60-62 and spacer 63 seated in the notches 21. As can be seen, a mat board corner sample 60 is seated in the notch marked “6”, a second mat board corner sample 61 is seated in notch “4”, and mat board corner sample 62 is seated in notch “3”. A spacer 63 is disposed between mat board corner samples 61 and 62 and is seated in notch “2”. The spacer 63 can be included with the mat board combination in order to create a depth effect. The spacer can be made of various materials of varying thicknesses, but is preferably a piece of foam board having front and rear paper backings and a foam core.

FIG. 20 illustrates the mounting of artwork with a combination of mat board and frame corner samples. The mat board corner samples may be slightly flexed so that they can be inserted under cover 26 and seated in a pair of notches 21 as is shown with mat 62. Once the mat board corner sample is inserted it is released and unflexes so that it is snuggly seated in a corresponding pair of notches as shown with mats 60 and 61. Once the desired mat combination is in place, the artwork 50 may be slid under the mats and positioned with the mat board corner samples overlying the work. Alternatively, the artwork 50 may be laid down first and then the mat board corner samples may be placed on top of it. The work 50 is held in place by adhesive strip 13. A frame corner 64 is then seated on the corner of the display board 11 and rests over the mat board corner samples 60-62. Thus, a frame and mat board combination may be presented in combination in a horizontal, vertical, or semi-vertical orientation.

If spacers are to be included with the mat board combinations, it may be desirable to provide a means for hinging those spacers that are too ridged to be flexed for seating in the notch pairs. For example, if a foam board is used as a spacer, slicing through one of the paper backings and the foam core will create a suitable hinge and permit the foam board to be flexed and seated into a notch pair.

The display board 11 may also include a series of measurement markings 16 as shown in FIG. 20. The markings 16 can be used to quickly determine the distance from the edges 14 and 15 of the display board 11 to the inner edge of the mat board corner samples 60-62.

As shown in FIG. 16, the display holder 10 may be provided in combination with a stand 1. The stand assists in the holding and display of the artwork with mat and frame combinations. The stand 1 may be an easel or any other suitable means for supporting the display holder 10. The stand may be a tripod type stand, or a post type stand and shown and described with respect to FIGS. 7 and 8 above.

In addition, end members of other shapes such as end members 320 and 324 may used with display holder 10 and may be mounted on the display board 11 so that chevron shaped mat board corner samples can also be display.

The mat holders of the present invention are not limited to use in combination with the framing of artwork and can be used for other applications, including the framing of certificates and diplomas.

Having described embodiments of the invention with reference to the accompanying drawings, it is to be understood that the invention is not limited to those precise embodiments, and that various changes and modifications may be effected therein by one skilled in the art without departing from the scope or spirit of the invention.

I claim:

1. A device for displaying and holding mat board corner samples, comprising:
a support member;
two end members attached to the support member and spaced apart and oriented with respect to each other such that at least one mat board corner sample can be removably seated between the two end members at a plurality of locations; and
registration means extending from at least one of the support member and the two end members for removably seating the end members in a corner of a display board.

2. The device as in claim 1, wherein the two end members each include a plurality of notches, the notches being located on the two end members such that a first notch located on one end member and a second notch located on the other end member are located on the respective end members in a corresponding position such that they form a corresponding notch pair, each notch of the corresponding notch pair being sized and positioned to seat a respective outer end corner of an L-shaped mat board corner sample.

3. The device as in claim 1, wherein the two end members each include a respective flat surface, the two end members being spaced and orientated so that respective angled edges of a chevron-shaped mat board corner sample can be slidably seated between the flat surfaces.

4. The device as in claim 3, wherein at least one of the two end members includes a resilient compressible member extending from the flat surface of the end member, the resilient member being adapted to compress when a chevron-shaped mat board corner sample is slidably seated between the flat surfaces.

5. A display holder for displaying and holding mat board corner samples, comprising:
a display board; and
two end members mounted near a corner of the display board and spaced apart and oriented with respect to each other such that at least one mat board corner sample can be removably seated between the two end members at a plurality of locations in said corner.

6. The display holder as in claim 5, wherein the two end members each include a plurality of notches, the notches being located on the two end members such that a first notch located on one end member and a second notch located on the other end member are located on the respective end members in a corresponding position such that they form a corresponding notch pair, each notch of the corresponding notch pair being sized and positioned to seat a respective outer end corner of a L-shaped mat board corner sample.

7. The display holder as in claim 6, wherein the two end members each include a respective flat surface, the two end members being spaced and orientated so that respective angled edges of a chevron-shaped mat board corner sample can be slidably seated between the flat surfaces.
